(19) United States
(12) Patent Application Publication
(10) Pub. No.: US 2013/0132240 A1
(43) Pub. Date: May 23, 2013

(54) SYSTEM AND METHOD FOR ONLINE SHOPPING WITH INTEGRATED SOCIAL EXPERIENCE

(71) Applicant: Teresa Aguilar, London (GB)

(72) Inventor: Teresa Aguilar, London (GB)

(21) Appl. No.: 13/300,421

(22) Filed: Nov. 18, 2011

(51) Int. Cl. G06Q 30/00

(52) U.S. Cl. 705/27.2

(57) ABSTRACT

A method for online shopping in an online shopping system includes providing a first user interface identifying an item of apparel for presentation to a first user and providing a second user interface identifying the item of apparel for presentation to a second user. The method also includes receiving from the first user an indication to associate the item of apparel with an outfit. The user further includes receiving from the second user a comment regarding at least one of the outfit and the item of apparel. In addition, the method includes providing the comment and the outfit for presentation in the first and second user interfaces such that the comment and outfit are viewable by the first user and the second user.

### TECHNICAL FIELD

The present disclosure is directed in general to online shopping and more specifically to an online shopping environment that incorporates a social experience for a user while shopping.

### BACKGROUND

Online shopping for apparel and other merchandise has been the fastest growing sales channel in the past few years and is expected to continue to outgrow all other channels in the near future. Consumer sentiment towards online shopping is changing due to factors such as the development of more secure methods for online payments, a higher percentage of working women with little time for shopping, and an economic environment that has prompted consumers to shop for bargains online.

Traditional retailers are aware of this trend and are launching online stores. At the same time, new models of online stores and fashion-related networks are emerging, such as group buying or sites that sell clothes from different brands.

### SUMMARY

According to one embodiment of this disclosure, a method for online shopping is provided. The method includes providing a first user interface identifying an item of apparel for presentation to a first user and providing a second user interface identifying the item of apparel for presentation to a second user. The method also includes receiving from the first user an indication to associate the item of apparel with an outfit. The user further includes receiving from the second user a comment regarding at least one of the outfit and the item of apparel. In addition, the method includes providing the comment and the outfit for presentation in the first and second user interfaces such that the comment and outfit are viewable by the first user and the second user.

According to another embodiment of this disclosure, a data processing system for online shopping is provided. The data processing system includes at least one processing unit and at least one memory. The at least one processing unit is configured to provide a first user interface identifying an item of apparel for presentation to a first user, provide a second user interface identifying the item of apparel for presentation to a second user, receive from the first user an indication to associate the item of apparel with an outfit, receive from the second user a comment regarding at least one of the outfit and the item of apparel, and provide the comment and the outfit for presentation in the first and second user interfaces such that the comment and outfit are viewable by the first user and the second user.

A computer program product for use in an online shopping system is also provided. The computer program product includes a tangible machine-readable medium encoded with computer-executable instructions. When executed, the computer-executable instructions cause a data processing system to provide a first user interface identifying an item of apparel for presentation to a first user, provide a second user interface identifying the item of apparel for presentation to a second user, receive from the first user an indication to associate the item of apparel with an outfit, receive from the second user a comment regarding at least one of the outfit and the item of apparel, and provide the comment and the outfit for presentation in the first and second user interfaces such that the comment and outfit are viewable by the first user and the second user.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIGS. 1A and 1B illustrate an example user interface of an online shopping and social networking system according to an embodiment of this disclosure;

FIGS. 2A and 2B illustrate example operations of certain functions in the user interface according to an embodiment of this disclosure;

FIG. 3 illustrates an example outfit detail interface according to an embodiment of this disclosure;

FIG. 4 illustrates an example user profile interface according to an embodiment of this disclosure;

FIG. 5 illustrates an example friend management interface according to an embodiment of this disclosure;

FIG. 6 illustrates an example outfit management interface according to an embodiment of this disclosure;

FIG. 7 illustrates an example data processing system capable of implementing an online shopping and social networking system according to an embodiment of this disclosure; and

FIG. 8 illustrates an example method for using an online shopping and social networking system according to an embodiment of this disclosure.

### DETAILED DESCRIPTION

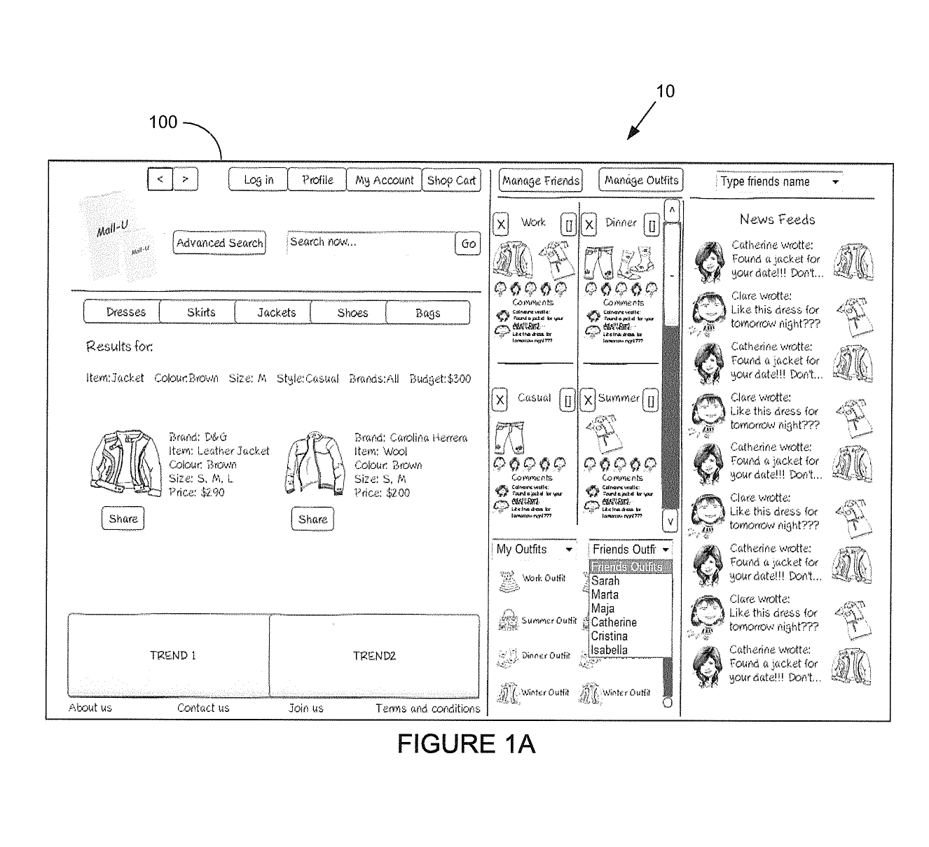

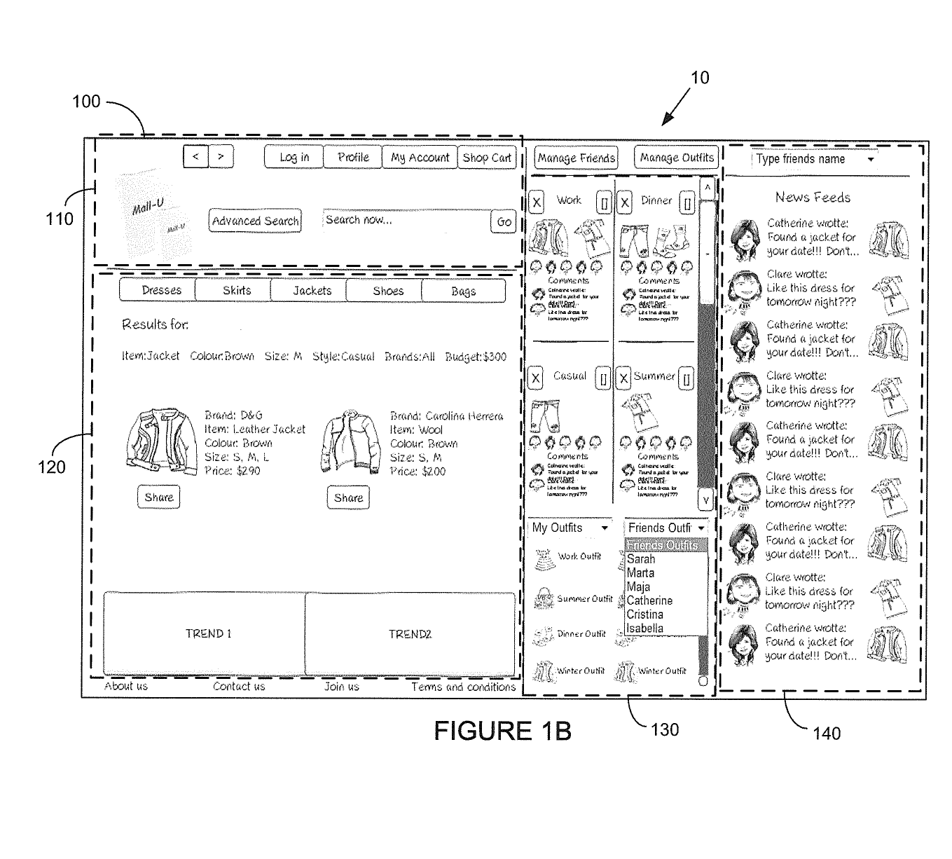

FIGS. 1A through 8, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

This disclosure describes an online shopping and social networking system where users can shop alone or with friends, simultaneously or in their own time. The system provides users a comprehensive venue to shop for the users' favorite brands and retailers, while at the same time including friends in the shopping experience.

The online shopping and social networking system according to this disclosure solves many of the problems found in conventional online shopping sites. For example, conventional online shopping sites have not been able to reproduce the social element of shopping. Many people believe that going shopping is a leisure and social activity, but they do not experience this when they shop online because conventional online shopping sites do not promote interaction with friends. Furthermore, conventional online shopping sites often make it difficult for a consumer to shop among more than one brand or one retailer. Manufacturers and retailers are launching their own online stores, but they typically only sell one brand or from one retailer. Multi-brand/multi-retailer sites are typically not properly integrated and often redirect the consumer to a single manufacturer's website. Finally, search engine results for clothing are not always relevant to the consumer's search, causing frustration for the consumer.

The online shopping and social networking system according to this disclosure introduces a missing element of fun into online shopping by making it an enjoyable social activity. The disclosed system enables friends to go shopping online together, either in real time or by having access to each other's “outfits” and making recommendations and comments. The system provides visual tools for users to be able to “model” garments with their friends, as well as real-time chatting capabilities. Users retain full control over who sees their selections by making each outfit or apparel item visible to as few or as many friends as desired. Users are also able to shop privately if desired. The system also provides links to fashion magazines, blogs, or other information that shoppers can use for inspiration.

While the online shopping and social networking system is described herein with respect to apparel shopping, it will be understood to those of skill in the art that the online shopping and social networking system may be used for shopping for other goods, such as jewelry and accessories, home furnishings, electronics, specialty foods, and any other suitable consumer goods.

Note that the online shopping and social networking system is described below with respect to various embodiments. The following description provides specific details for a thorough understanding of, and enabling description for, these embodiments of the disclosure. However, one skilled in the art will understand that the disclosure may be practiced without these details. In other instances, well-known structures and functions have not been shown or described in detail to avoid unnecessarily obscuring the description of the embodiments of the disclosure.

FIGS. 1A and 1B illustrate an example user interface 100 of an online shopping and social networking system 10 according to an embodiment of this disclosure. The embodiment of user interface 100 shown in FIGS. 1A and 1B is for illustration only. Other embodiments of user interface 100 could be used without departing from the scope of this disclosure.

Online shopping and social networking system 10 includes user interface 100. A user of online shopping and social networking system 10 (referred to as “shopping system 10”) accesses user interface 100 through a web browser, a computer application, a mobile device application, a combination of these, or in any other suitable manner. As shown in FIG. 1B, user interface 100 includes a search interface 110, a shopping interface 120, an outfit interface 130, and a comment interface 140. Search interface 110 is an innovative search engine specifically designed to search for fashion in a multi-brand environment. For example, search interface 110 can enable a user to search for a clothing item, a retailer, a brand, or any other category. In some embodiments, search interface 110 is a portal to an existing search engine. In other embodiments, search interface 110 is a fully-integrated search engine that is designed, developed, and optimized specifically for shopping system 10.

Shopping interface 120 displays one or more items of apparel and associated information, such as a description, brand, color, size, style, trend, price, and so forth. The items displayed in shopping interface 120 may reflect a result set of a search performed by a user using search interface 110. That is, after a user performs a search for items using search interface 110, the results of the search can be displayed in shopping interface 120. Some or all of the information associated with each item may be obtained directly from a manufacturer, vendor, retailer, or other third party. For example, availability and delivery date information can be provided by a retailer associated with each item. In other embodiments, some or all of the information associated with each item may be compiled or provided by systems or personnel associated with shopping system 10. In particular embodiments, shopping interface 120 may include, or be executed by, existing shopping engine software. In other particular embodiments, shopping interface 120 is a fully-integrated shopping engine that is designed, developed, and optimized specifically for shopping system 10. Any other suitable functions could be supported by shopping interface 120. For instance, shopping interface 120 could enable the user to buy one or more items with one-click buying in shopping system 10 and continue shopping in the same session.

Outfit interface 130 displays items of apparel, both individually and arranged into outfits. As used in this document, an “outfit” includes two or more items of apparel selected to be displayed or worn together. Outfits displayed in outfit interface 130 may be assigned to and arranged by one or more categories, such as work outfits, summer outfits, dinner outfits, and the like. Outfit interface 130 is configured to display outfits associated with a user of shopping system 10, as well as outfits associated with friends of the user. Users may select from their own outfits or from those of their friends by clicking on an icon, selecting from a drop-down list, or in any other suitable manner. A user may add, delete, update, or rearrange outfits in outfit interface 130, such as by dragging and dropping icons associated with each outfit or in any other suitable manner. In certain embodiments, outfit interface 130 could enable the user to buy one or more items, or an entire outfit, with one-click buying. Support for one-click buying in outfit interface 130 could be instead of, or in addition to, the one-click buying support in shopping interface 120.

Comment interface 140 enables a user to read, write, and edit comments regarding one or more items of apparel or outfits. The commented apparel items or outfits may be associated with the user or with one of the user's friends. For example, comment interface 140 enables the user to identify an item of apparel (such as by using shopping interface 120) and post a comment, such as “I like this jacket for my work.” Comment interface 140 also enables the user to read comments that have been posted by the user's friends. The comments posted by the user's friends may involve the user's apparel items or outfits or a friend's apparel items or outfits. The user may choose to accept a comment, which posts the comment with the outfit or item of apparel in outfit interface 130, as shown in FIG. 1B. Alternatively, the user may choose to reject a comment, in which case the comment may be removed from comment interface 140, outfit interface 130, or both. In some embodiments, the user and the user's friends can respond to each others' comments with additional comments, thus creating a dialog regarding an item of apparel or an outfit.

The comments in comment interface 140 may be arranged in a list view, icon view, detail view, tree view, or any other suitable arrangement. The comments in comment interface 140 may be filtered or sorted by friend name, date, or any other suitable parameter. Comment interface 140 may also include a preview window (not shown) similar to those found in many email applications. As shown in FIG. 1B, each comment from a friend in comment interface 140 may include an avatar, icon, or image associated with that friend. In some embodiments, clicking on a friend's icon opens a profile page for the friend as described in greater detail below.

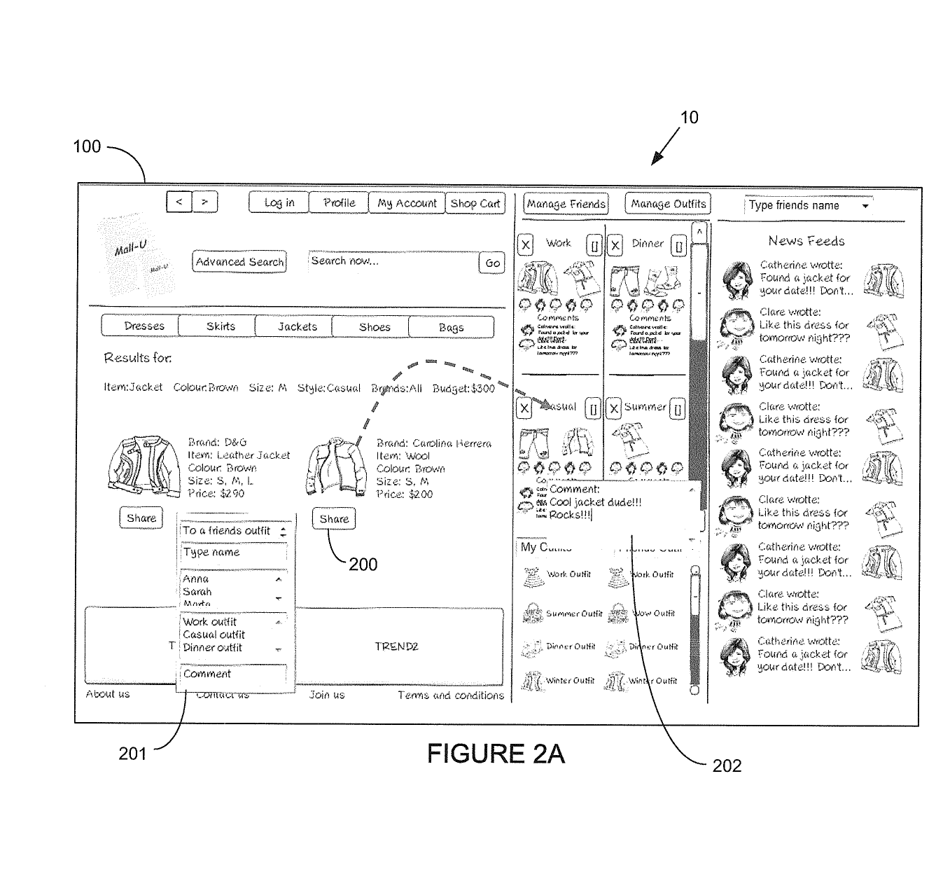

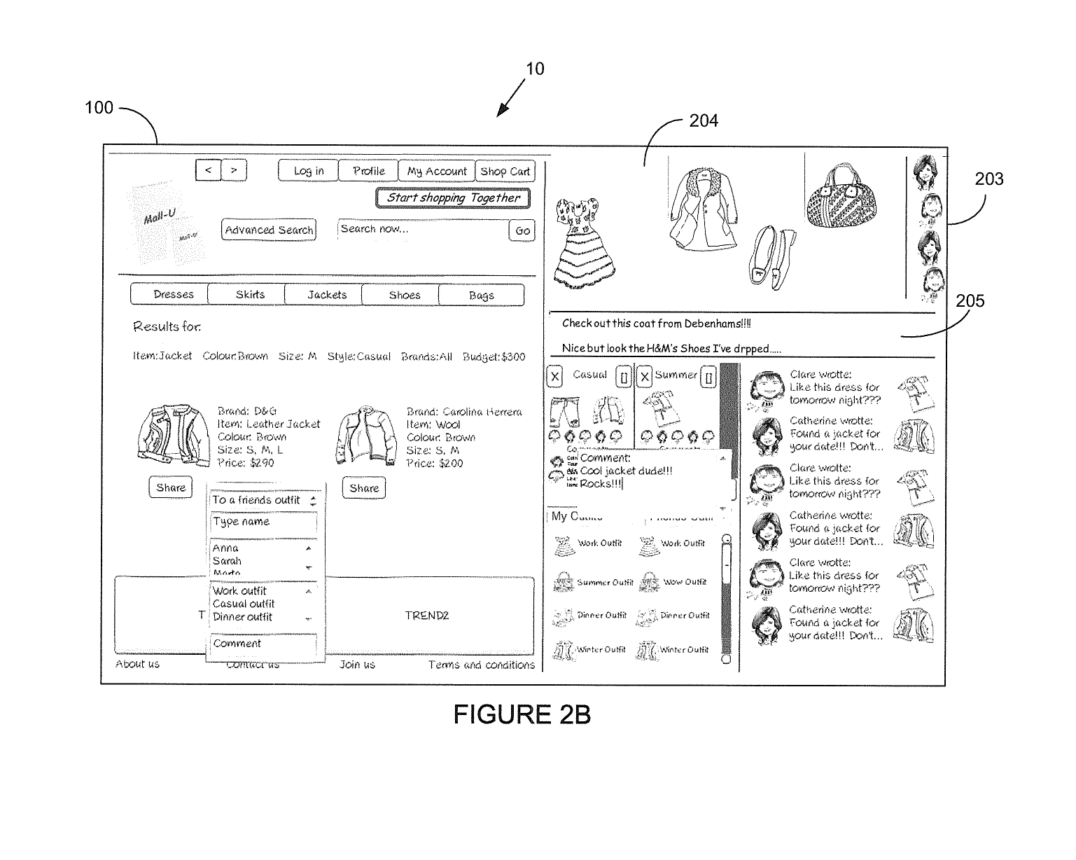

FIGS. 2A and 2B illustrate example operations of certain functions in the user interface 100 according to an embodiment of this disclosure. The operations shown in FIGS. 2A and 2B are for illustration only. Other operations could be performed without departing from the scope of this disclosure.

As shown in FIG. 2A, when a user clicks on a “Share” button 200 associated with an item of apparel in shopping interface 120, a dialog window 201 appears. Dialog window 201 enables the user to share information and opinions about the apparel item with one or more friends. For example, if a user believes that a jacket is a good addition to a friend's outfit, the user can open dialog window 201, select the friend's outfit, and assign or “add” the jacket to the friend's outfit. Once added, the jacket appears with the friend's outfit in outfit interface 130. As another example, if the user simply wants to show the jacket to a friend (without associating the jacket with an outfit), the user can open dialog window 201, select a friend, add an optional comment, and send an image of the jacket with the optional comment to the friend.

In addition to or in lieu of using dialog window 201, the user may drag and drop an apparel item from shopping interface 120 to outfit interface 130 as indicated by the dashed arrow line in FIG. 2A. By dragging and dropping the apparel item to outfit interface 130, a user associates the apparel item with one or more outfits in outfit interface 130. In some embodiments, when the user drags and drops an apparel item to outfit interface 130, a comment box 202 automatically appears. The comment box 202 enables the user to post or read one or more comments regarding the apparel item. In other embodiments, comment box 202 may not automatically appear but may appear upon user actuation of a control, such as by the user right-clicking on the icon for the apparel item.

User interface 100 includes features and functions to enable users of shopping system 10 to shop together even though the users are not physically in the same location. For example, as shown in FIG. 2B, user interface 100 may include an indication 203 of a user's friends that are accessing the shopping system 10 concurrently with the user's session. The indication 203 of each friend may include an avatar, a name, a user ID, or any other suitable indicator. User interface 100 may enable the user to invite one or more friends to shop concurrently with the user as described in greater detail below.

By actuating one or more user controls in user interface 100, a user may participate in a group chat, audio conference, or video conference with friends who are also using shopping system 10. User interface 100 may include screen sharing capabilities that enable the friends to concurrently view and model apparel items and outfits. For example, as shown in FIG. 2B, user interface 100 may include a common space 204 that is viewable and accessible by multiple users. In common space 204, each friend may display one or more apparel items that may or may not be associated with any outfit. Common space 204 may include a comment area 205 where the friends can chat and share opinions about the apparel items in common space 204.

User interface 100 may enable users to shop at different times but still share the shopping experience by being able to see the outfits that their friends are creating and making comments and recommendations. Of course, a user can also shop privately if desired by keeping some outfits private even if the user's friends are making recommendations and comments about other outfits.

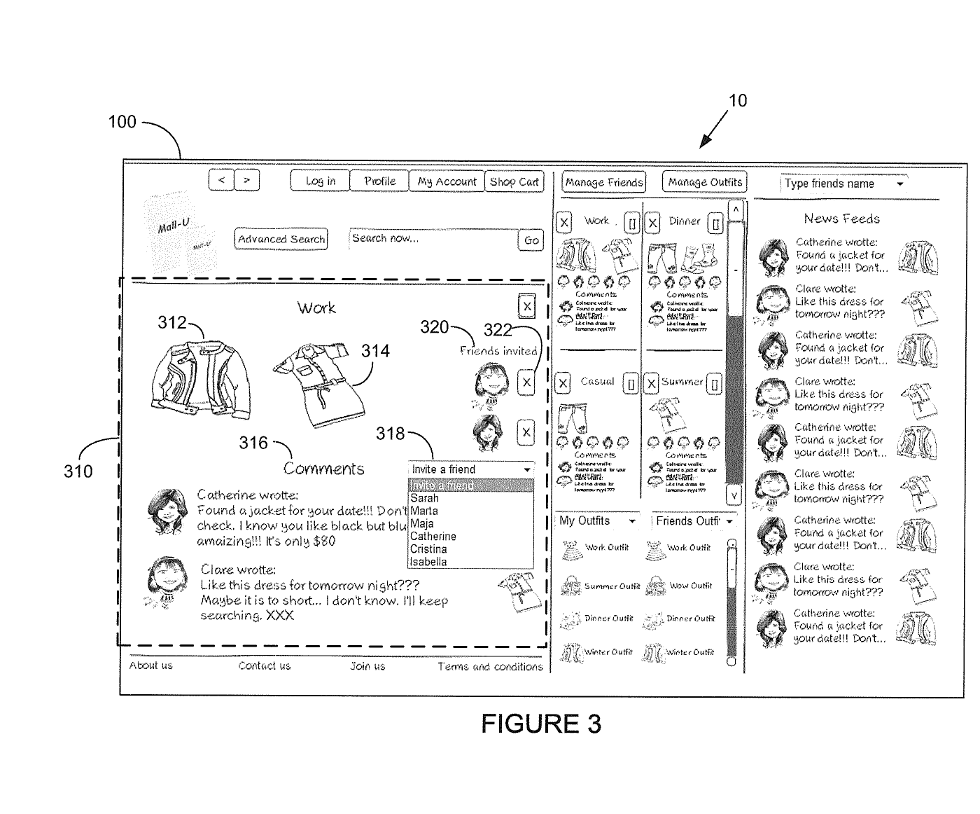

FIG. 3 illustrates an example outfit detail interface 310 according to an embodiment of this disclosure. The embodiment of outfit detail interface 310 shown in FIG. 3 is for illustration only. Other embodiments of outfit detail interface 310 could be used without departing from the scope of this disclosure.

As shown in FIG. 3, outfit detail interface 310 is part of user interface 100 but may be part of another interface or a stand-alone interface. Outfit detail interface 310 provides a detailed view of an outfit that is shown in outfit interface 130. Outfit detail interface 310 includes images 312-314 of the apparel items in the outfit. Images 312-314 can be resized and moved around within a defined space in outfit detail interface 310. In some embodiments, outfit detail interface 310 may include a mannequin function to enable the user to display or “model” the images 312-314 on a virtual mannequin. The virtual mannequin may have a generic appearance or may be customized to have an appearance similar to the user or one of the user's friends.

Outfit detail interface 310 also includes a comments section 316 configured to display the comments associated with the outfit. Comments section 316 may be larger than the comment spaces shown in outfit interface 130 and comment interface 140, thus enabling the user to read more of each comment or read each comment in a larger font without the need to scroll. An invitation list 318 enables the user to select one or more friends to view the outfit displayed in outfit detail interface 310. Friends that are already invited to view the outfit appear in a friend section 320 of outfit detail interface 310. A button 322 next to each invited friend enables the user to “un-invite” that friend (i.e., remove authorization for that friend to view the outfit.)

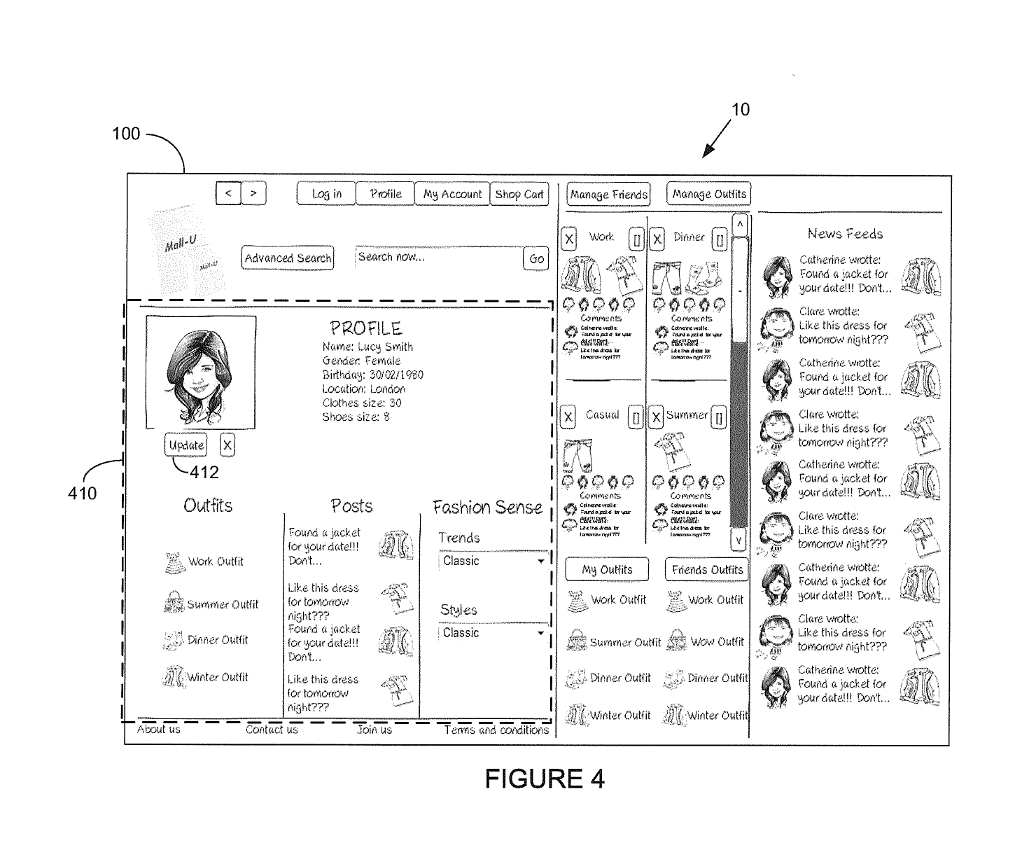

FIG. 4 illustrates an example user profile interface 410 according to an embodiment of this disclosure. The embodiment of user profile interface 410 shown in FIG. 4 is for illustration only. Other embodiments of user profile interface 410 could be used without departing from the scope of this disclosure.

As shown in FIG. 4, user profile interface 410 is part of user interface 100 but may be part of another interface or a stand-alone interface. User profile interface 410 enables the user to manage the user's system account, profile, and interactions with friends in shopping system 10. User profile interface 410 displays editable information about the user, such as name, gender, birthday, location, user name, password, email address, clothing sizes, and the like. The information in user profile interface 410 may also include payment and delivery information (e.g., credit card numbers, shipping addresses, and the like) associated with making purchases using shopping system 10. The information in user profile interface 410 may further include fashion sense information, such as clothing or color preferences and trends or styles that the user likes or follows. By actuating a control, such as an update button 412, a user can use user profile interface 410 to update, add, delete, or edit information in the user profile. In some embodiments, certain user profile information is read-only, such as friends' outfits that the user is authorized to see and comment on. Comments and posts—such as those posted to the user, by the user, or both—may be displayed in user profile interface 410. The comments and posts may be editable or may be read-only in user profile interface 410.

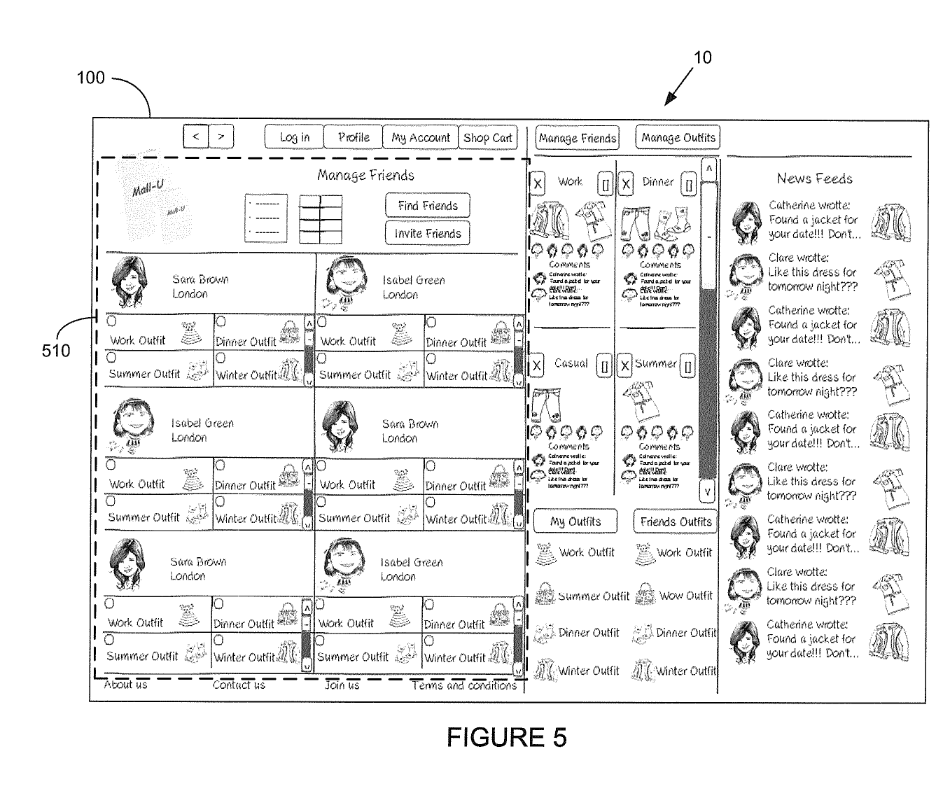

FIG. 5 illustrates an example friend management interface 510 according to an embodiment of this disclosure. The embodiment of friend management interface 510 shown in FIG. 5 is for illustration only. Other embodiments of friend management interface 510 could be used without departing from the scope of this disclosure.

As shown in FIG. 5, friend management interface 510 is part of user interface 100 but may be part of another interface or a stand-alone interface. Friend management interface 510 enables the user to manage interactions with friends in shopping system 10 by adding, deleting, updating, and viewing authorization and profiles of friends who use shopping system 10. Friend management interface 510 can also display information associated with a friend, such as name, gender, birthday, location, contact information, clothing sizes, clothing and color preferences, and the like. Friend management interface 510 can further display outfit information associated with each friend. For example, friend management interface 510 may display the user's apparel items or outfits that each friend is authorized to view, update, or comment on. As another example, friend management interface 510 may display the friend's apparel items or outfits that the user is authorized to view, update, or comment on. The information in friend management interface 510 may be displayed in a list view, icon view, tree view, detail view, or any other suitable arrangement. In some embodiments, some of the friend profile information (such as name, gender, and the like) can be read-only, while other information (such as user outfit authorization) can be editable by the user.

Friend management interface 510 may enable a user to search for friends and invite friends to be part of the friend list of shopping system 10. Once added to the friend list, friends in the shopping system 10 can shop together, exchange ideas and comments, participate in audio or video conferences or group chats, and so forth. The disclosed system may enable a user to search for friends using an integrated search engine. Additionally or alternatively, shopping system 10 may enable friend searches and management through interfaces with other social networking applications, such as FACEBOOK, SKYPE, and the like. Friend management interface 510 may also enable a user to delete or “un-friend” a friend from the user's friend list. When a friend is deleted from shopping system 10, each of the friend's outfits can be removed from display in user interface 100, and the user's outfits that the deleted friend was authorized to view can no longer be viewable when the friend accesses shopping system 10.

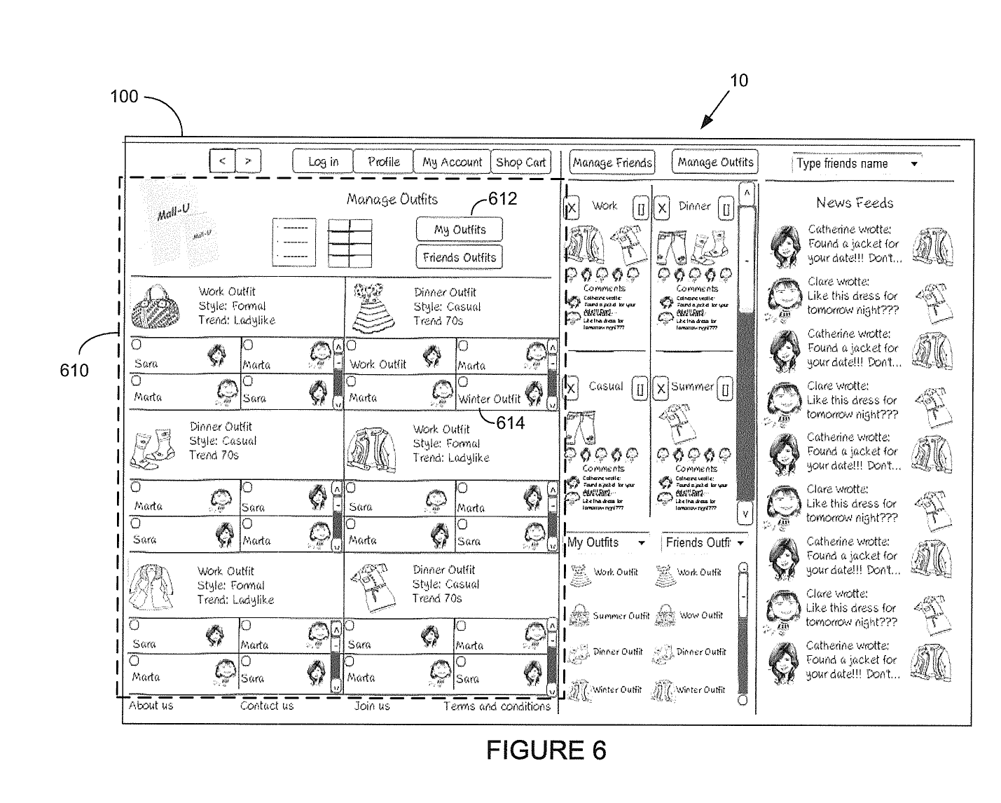

FIG. 6 illustrates an example outfit management interface 610 according to an embodiment of this disclosure. The embodiment of outfit management interface 610 shown in FIG. 6 is for illustration only. Other embodiments of outfit management interface 610 could be used without departing from the scope of this disclosure.

As shown in FIG. 6, outfit management interface 610 is part of user interface 100 but may be part of another interface or a stand-alone interface. Outfit management interface 610 enables the user to manage the user's own outfits and the user's interactions with friends' outfits. In some embodiments, outfit management interface 610 displays only the user's outfits or only the friends' outfits at one time. One or more user controls, such as buttons 612, enable the user to select whether the user's outfits or the friends' outfits are displayed in outfit management interface 610. In other embodiments, outfit management interface 610 may display both the user's outfits and the friends' outfits together.

Outfit management interface 610 includes one or more user controls that enable the user to add, delete, update, and view the user's own outfits. For example, the user may actuate one or more controls to create a new dinner outfit or actuate one or more controls to update or delete an existing work outfit. Creating a new outfit or updating an existing outfit may include, for example, searching for and adding one or more apparel items to the outfit.

Outfit management interface 610 also includes one or more user controls 614 that enable the user to add, delete, update, and view authorizations of friends to view and comment on each of the user's outfits. For example, the user may want to allow one friend to view and comment on a work outfit but restrict another friend from viewing the work outfit. The user may actuate one or more controls 614 in outfit management interface 610 to set the associated authorizations.

While configured to display friends' outfits, outfit management interface 610 may display the names or identifiers of all friends who are authorized to view or comment on each friend's outfit, regardless of whether or not the displayed names are friends of the user. A user control associated with the displayed names, such as an “Add Friend” button, enables the user to add a person to the user's friend list that is not currently the user's friend. For example, assume Lucy views her friend Sophie's outfits in outfit management interface 610 and Lucy notices that Sophie has authorized Isabelle to view Sophie's work outfit. If Isabelle is not currently a friend of Lucy, then Lucy may invite Isabelle to be Lucy's friend.

Although FIGS. 1A through 6 illustrate various examples of user interfaces in shopping system 10, it will be understood that the described user interfaces are merely examples and that various changes may be made to the user interfaces. For example, the interfaces may include more or fewer controls and functions. Also, certain components of the interfaces may be combined, separated, added, removed, or rearranged in different configurations.

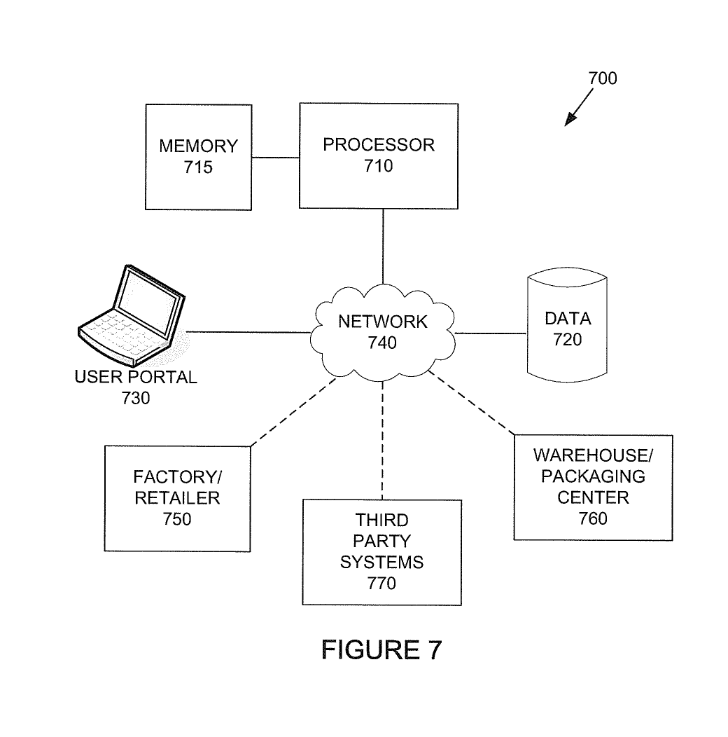

FIG. 7 illustrates an example data processing system 700 capable of implementing an online shopping and social networking system 10 according to an embodiment of this disclosure. The embodiment of data processing system 700 shown in FIG. 7 is for illustration only. Other embodiments of data processing system 700 could be used without departing from the scope of this disclosure.

As shown in FIG. 7, data processing system 700 includes at least one processor 710 coupled to at least one memory 715 and at least one data storage 720 connected through a network 740. The at least one processor 710 includes any suitable processing unit or other device, such as a microprocessor. The at least one memory 715 includes any suitable volatile and/or non-volatile storage and retrieval device(s). Data processing system 700 is coupled to one or more user portals, such as user portal 730. Data processing system 700 may also communicate with one or more factories or retailers 750, warehouses or packaging centers 760, and third party systems 770.

Processor 710 is connected to network 740, which may or may not be a part of data processing system 700. Network 740 can be any public or private data processing system network or combination of networks as known to those of skill in the art, including the Internet. Processor 710 communicates over network 740 with user portal 730 and data storage 720. Processor 710 executes one or more programs, applications, or software functions to implement shopping system 10. Processor 710 receives user inputs and other data from user portal 730. Processor 710 transmits data to user portal 730 that is associated with graphical images or audible sounds that are presented in a user interface (e.g., user interface 100) of shopping system 10. In some embodiments, at least part of the programs, applications, or software functions to implement shopping system 10 are executed at user portal 730.

Memory 715 and data storage 720 can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

In some embodiments, data processing system 700 may also include one or more of a cache/bridge, a local system bus, a peripheral component interconnect (PCI) architecture bus, a graphics adapter, display, network adapter, expansion bus interface, input/output (I/O) bus, keyboard/mouse adapter, disk controller, and I/O adapter. Those of ordinary skill in the art will appreciate that the hardware depicted in FIG. 7 may vary for particular embodiments. For example, other peripheral devices, such as an optical disk drive and the like, may be used in addition or in place of the hardware depicted. The depicted example is provided for the purpose of explanation only and is not meant to imply architectural limitations with respect to the present disclosure.

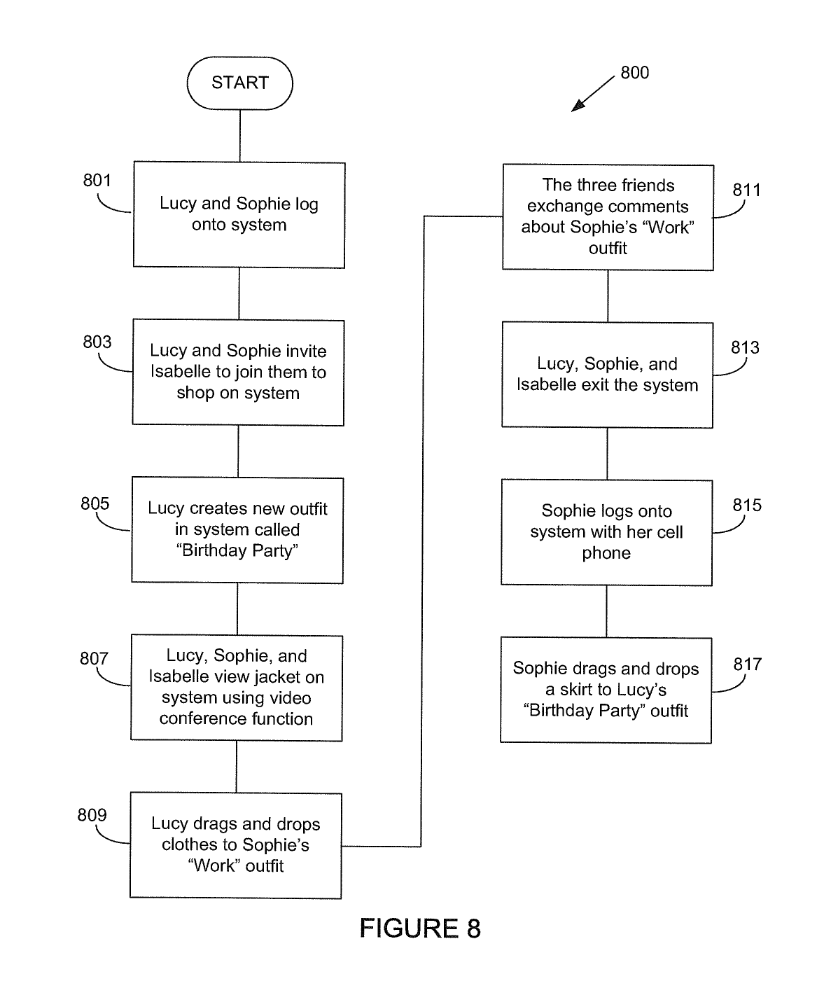

FIG. 8 illustrates an example method 800 for using an online shopping and social networking system according to an embodiment of this disclosure. For ease of explanation, the method 800 is described as being used in conjunction with shopping system 10. The method 800, however, may be used with any other suitable system. Also, other embodiments of the method 800 may be used without departing from the scope of this disclosure.

Lucy logs onto shopping system 10 at an agreed time with her friend Sophie to buy something to wear for her best friend's birthday party (block 801). Lucy and Sophie may log on to shopping system 10 using the same terminal or different terminals. Lucy and Sophie find that their friend Isabelle is also shopping at the system and they invite her to join them (block 803). Lucy tells Sophie and Isabelle that she needs to find a short red skirt for less than $100 and creates a new outfit called “Birthday Party” (block 805).

A few minutes later, Isabelle at home receives the jacket she bought yesterday using shopping system 10, so the three friends start a video conference session to see how the jacket fits Isabelle (block 807). They agree that Isabelle should keep the jacket.

While browsing, Lucy comes across some apparel items that she thinks Sophie could like for going to work, so Lucy drags and drops them to Sophie's “Work” outfit (block 809). The three friends exchange comments on that outfit, and Sophie buys the whole outfit while continuing to browse with her friends (block 811). After a period of time, the friends exit the system with the feeling of having spent an afternoon shopping together, although they may live in different cities (block 813).

The next day, on her way to work, Sophie comes across a nice red short skirt in the window of her favorite store, so she logs on to shopping system 10 with her cell phone (block 815). Sophie finds the skirt by searching in shopping system 10, and she drags and drops the skirt into Lucy's “Birthday Party” outfit, so Lucy can see it later and decide if she likes it (block 817).

Although FIG. 8 illustrates one example of a method 800 for using shopping system 10, various changes may be made to FIG. 8. For example, while shown as a series of steps, various steps in FIG. 8 may overlap, occur in parallel, occur in a different order, or occur multiple times.

Although the figures above illustrate specific systems, structures, and methods, various changes may be made to the figures. For example, various components in the systems and structures can be combined, omitted, further subdivided, or moved according to particular needs. In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure, has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for online shopping in an online shopping system, the method comprising:
providing a first user interface identifying an item of apparel for presentation to a first user;
providing a second user interface identifying the item of apparel for presentation to a second user;
receiving from the first user an indication to associate the item of apparel with an outfit;
receiving from the second user a comment regarding at least one of the outfit and the item of apparel; and
providing the comment and the outfit for presentation in the first and second user interfaces such that the comment and outfit are viewable by the first user and the second user.

2. The method of claim 1, wherein the first user accesses the online shopping system from a first location and receives the comment from the second user who accesses the online shopping system concurrently from a different second location.

3. The method of claim 1, wherein the outfit is defined by the first user.

4. The method of claim 1, wherein the outfit is defined by the second user.

5. The method of claim 1, further comprising:
receiving from the first user a request to associate the second user as a friend with the first user.

6. The method of claim 1, further comprising:
providing the outfit on a virtual mannequin for presentation in the first and second user interfaces, wherein the virtual mannequin is visible concurrently to the first user and the second user.

7. The method of claim 1, further comprising:
initiating at least one of a group chat, an audio conference, and a video conference between the first user and the second user.

8. A data processing system for online shopping comprising at least one processing unit and at least one memory, the at least one processing unit configured to:
provide a first user interface identifying an item of apparel for presentation to a first user;
provide a second user interface identifying the item of apparel for presentation to a second user;
receive from the first user an indication to associate the item of apparel with an outfit;
receive from the second user a comment regarding at least one of the outfit and the item of apparel; and
provide the comment and the outfit for presentation in the first and second user interfaces such that the comment and outfit are viewable by the first user and the second user.

9. The data processing system of claim 8, wherein the data processing system is configured to interact with the first user and the second user concurrently.

10. The data processing system of claim 8, wherein the at least one processing unit is further configured to receive a definition of the outfit from the first user.

11. The data processing system of claim 8, wherein the at least one processing unit is further configured to receive a definition of the outfit from the second user.

12. The data processing system of claim 8, wherein the at least one processing unit is further configured to receive from the first user a request to associate the second user as a friend with the first user.

13. The data processing system of claim 8, wherein the at least one processing unit is further configured to provide the outfit on a virtual mannequin for presentation in the first and second user interfaces.

14. The data processing system of claim 8, wherein the at least one processing unit is further configured to initiate one of a group chat, an audio conference, and a video conference between the first user and the second user.

15. A computer program product for use in an online shopping system, the computer program product comprising a tangible machine-readable medium encoded with computer-executable instructions that when executed cause a data processing system to:
provide a first user interface identifying an item of apparel for presentation to a first user;
provide a second user interface identifying the item of apparel for presentation to a second user;
receive from the first user an indication to associate the item of apparel with an outfit;
receive from the second user a comment regarding at least one of the outfit and the item of apparel; and
provide the comment and the outfit for presentation in the first and second user interfaces such that the comment and outfit are viewable by the first user and the second user.

16. The computer program product of claim 15, wherein the computer-executable instructions when executed further cause the data processing system to interact with the first user and the second user concurrently.

17. The computer program product of claim 15, wherein the computer-executable instructions when executed further cause the data processing system to receive a definition of the outfit from at least one of the first user and the second user.

18. The computer program product of claim 15, wherein the computer-executable instructions when executed further cause the data processing system to receive from the first user a request to associate the second user as a friend with the first user.

19. The computer program product of claim 15, wherein the computer-executable instructions when executed further cause the data processing system to provide the outfit on a virtual mannequin for presentation in the first and second user interfaces.

20. The computer program product of claim 15, wherein the computer-executable instructions when executed further cause the data processing system to initiate at least one of a group chat, an audio conference, and a video conference between the first user and the second user.
